(19) United States
(12) Patent Application Publication
(10) Pub. No.: US 2025/0052634 A1
(43) Pub. Date: Feb. 13, 2025

(54) DIAPHRAGM FOR USE WITH HYDROGEN-CONTAINING FLUID MEDIA AND TRANSDUCER COMPRISING SUCH A DIAPHRAGM

(71) Applicant: Kistler Holding AG, Winterthur (CH)

(72) Inventors: Giovanni Mastrogiacomo, Zuerich (CH); Hans Beat Maerki, Kollbrunn (CH); Thomas Cadonau, Kirchberg (CH)

(21) Appl. No.: 18/721,687

(22) PCT Filed: Nov. 9, 2022
(86) PCT No.: PCT/EP2022/081288

§ 371 Date: Jun. 19, 2024

(30) Foreign Application Priority Data
Dec. 23, 2021 (EP) 21217511.1

(51) Int. Cl. G01L 19/06; B01D 69/12; B01D 71/02; G01L 9/00

(52) U.S. Cl. CPC G01L 19/0645; G01L 9/008; G01L 19/0672; B01D 69/12; B01D 71/0223

(57) ABSTRACT

A diaphragm for hermetically separating a first space accommodating a hydrogen-containing fluid medium from a second space. The diaphragm includes a metallic material and a coating that has properties effecting a reduction of the permeability for molecular and/or atomic hydrogen. The coating is arranged between the metallic material of the diaphragm and the fluid medium at least in an area that shields the metallic material from coming into contact with the fluid medium when the diaphragm is in use. The coating includes at least one non-stoichiometric oxide, carbide or nitride.

### CROSS REFERENCE TO RELATED APPLICATIONS

The present application claims priority to International Application Serial No. PCT/EP2022/081288, which is hereby incorporated herein in its entirety by this reference for all purposes.

### FIELD OF THE INVENTION

The invention relates to a diaphragm for use with hydrogen-containing fluid media and to a transducer comprising such a diaphragm.

### BACKGROUND OF THE INVENTION

A diaphragm separates a fluid medium in a first space from a second space. In the field of pressure measurement technology, transducers often comprise a diaphragm. The diaphragm separates a measuring arrangement, for example a transducer element, from the fluid medium for which the pressure is to be determined. A fluid medium is a gaseous and/or a liquid medium. For this purpose, a diaphragm usually comprises a surface having first and second dimensions, which first and second dimensions substantially extend in directions perpendicular to a longitudinal axis. In a third dimension that extends parallel to the longitudinal axis, the diaphragm has a thickness, also called wall thickness.

In the following, a fluid medium is understood to mean a hydrogen-containing fluid medium that contains at least 1% by volume of hydrogen.

Generally, the surface of the diaphragm comprises an area that is in contact with the fluid medium in a first space. In the case of a pressure transducer, the pressure of the fluid medium acting onto the area of the diaphragm is transmitted to a pressure transducer element, shortly named transducer element, with as little loss as possible. The flexibility of the diaphragm area that is directly exposed to the fluid medium must be as high as possible or its stiffness as low as possible, respectively, so that the sensitivity of a measuring arrangement comprising the transducer element is not affected too much by the diaphragm. However, the material in this low stiffness area should not be irreversibly deformed by the measuring pressure. When materials with a yield strength of around 400 MPa (megapascals) are used, the diaphragm must be made appropriately thick so as not to be irreversibly deformed. Furthermore, the diaphragm may comprise thicker areas by which the diaphragm is connected to a transducer housing, for example. The thicker areas may also serve to improve the stability of the diaphragm.

The yield strength of a metallic material is determined by means of standard DIN EN ISO 6892-1. It corresponds to the R_{P 0.2.} value.

The surface of a diaphragm may extend substantially along the first dimension and the second dimension, however, it may be partially curved in the direction of the longitudinal axis.

Diaphragms may also separate a fluid medium from other types of transducer elements, for example temperature transducers in which a temperature transducer element is separated from the fluid medium by a diaphragm. In this case, the temperature of the fluid medium is transmitted via the diaphragm to a temperature transducer element. Also in this case, the walls of the diaphragm should be made as thin as possible to obtain an as high heat transition coefficient as possible.

In general, corrosion is understood to mean a measurable change in a material. Corrosion may occur through exposure to a variety of substances. Thus, corrosion of metallic materials is well known in connection with various alkalis or acids, gases such as hydrogen or oxygen, salt water and many other substances.

In the following, however, unless stated otherwise, corrosion refers to corrosion caused by atomic and/or molecular hydrogen.

When the fluid medium contains hydrogen, the diaphragm must be both tight and resistant against atomic and/or molecular hydrogen. For this reason, commercially available hydrogen-resistant and polycrystalline metals, such as for example the austenitic steel 1.4404 (also known as 316 L) having a yield strength of around 400 MPa at room temperature or the nickel-based alloy 2.4819 (also known as C-276) also with a yield strength of around 400 MPa at room temperature, are often used as materials for diaphragms that are additionally heat-resistant at above 200° C. However, these materials are characterized by an average grain size of greater than 20 μm. Coarse-grained polycrystalline metals are less suitable as materials for thin diaphragms with thicknesses of less than 500 μm since only a few crystal grains are located in the thin-walled area of the diaphragms which is why the material may not show isotropic behavior. Furthermore, the diffusion path for molecular and/or atomic hydrogen along the grain boundaries between the crystal grains is relatively short through coarse-grained areas. This is a disadvantage since the short path may lead to hydrogen diffusing readily through the diaphragm.

The designation 1.4404 as well as other material numbers mentioned hereinbelow correspond to DIN EN 10027-2.

The so-called hydrogen embrittlement occurs when molecular and/or atomic hydrogen enters a metallic material. As a result, there is a risk of brittle fracture when the material is subjected to stresses.

By hydrogen embrittlement is meant a change in the ductility and strength of a metal or a metal alloy due to the entering and subsequent incorporation of hydrogen into the lattice structure of the metal or metal alloy. As a result, hydrogen-related cracking can occur, limiting the use of susceptible materials in applications in contact with hydrogen.

It is well known that a metal or a metal alloy having a high strength is more prone to hydrogen embrittlement than a metal with lower strength.

The materials steel 1.4404 (also known as 316 L) and alloy 2.4819 (also known as C-276) are generally considered as corrosion resistant. They have low yield strengths and, therefore, show higher plastic deformability even under a smaller force than materials with higher yield strengths. To compensate for this disadvantage, diaphragms are often manufactured with a thickness of more than 500 μm. This is a disadvantage, however, because a thick diaphragm has a high inertial mass. Furthermore, for a thick diaphragm also the rigidity is higher.

In a known embodiment, pressure transducers comprise a space behind the diaphragm that is filled with a fluid pressure transmission medium. In this embodiment, there is a lower risk that the diaphragm will undergo irreversible plastic deformation because the fluid pressure transmission medium counteracts deformation of the diaphragm. The fluid pressure transmission medium, for example an oil with low compressibility, transmits the pressure that acts onto the diaphragm to a measuring element spaced apart from the diaphragm. Further, it is required that the diaphragm transmits the pressure with as little loss as possible, i.e. advantageously the diaphragm should be made thin. If the fluid medium to be measured contains hydrogen, the hydrogen will accumulate in the fluid pressure transmission medium overtime causing its volume to increase and the diaphragm to bulge outwards. The diaphragm is inflated by the hydrogen that has diffused through the diaphragm. This may damage the diaphragm on the one hand and change the pressure conditions in the proximity of the measuring element on the other hand. The diffusion of molecular and/or atomic hydrogen through the diaphragm has a negative effect on the long-term stability of the transducer.

The document US20050109114A1, which is hereby incorporated herein in its entirety by this reference for all purposes, describes a transducer comprising a diaphragm made of alloy 2.4819 (also known as C-276). Although the material itself is considered to be corrosion-resistant, it is not impervious to hydrogen due to the small thickness of the diaphragm. Diffusion of molecular and/or atomic hydrogen shall be prevented by depositing a soft gold layer onto the diaphragm. The gold layer is substantially chemically inert and, thus, reduces the dissociation of molecular components from a fluid medium in contact with the diaphragm. Dissociation of molecular components of a fluid medium or other chemical reactions at and with a surface may lead to corrosion of the surface. However, due to the low strength of gold the soft gold layer is not scratch-resistant and may therefore be damaged during use and afterwards no longer fulfil its function as a diffusion barrier against hydrogen.

### EXEMPLARY OBJECTS AND SUMMARY OF THE INVENTION

It is the object of the present invention to improve a diaphragm to mitigate the disadvantages mentioned above. It is a further object of the invention to achieve an improved corrosion resistance of the diaphragm against atomic and/or molecular hydrogen.

The object has been achieved by the features described more fully below.

The invention relates to a diaphragm for hermetically separating a first space accommodating a hydrogen-containing fluid medium from a second space. The diaphragm comprises metallic material. The diaphragm comprises a coating for reducing the permeability for molecular and/or atomic hydrogen, which coating is deposited between the metallic material of the diaphragm and the fluid medium at least in an area that is in contact with the fluid medium during use. The coating comprises oxides, carbides or nitrides, for example aluminum oxides, aluminum carbides, aluminum nitrides, chromium oxides, chromium nitrides, silicon oxides, silicon carbides, silicon nitrides, titanium oxides, titanium carbides, titanium nitrides, zirconium oxides, rare earth carbides or nitrides or rare earth oxides.

According to the invention, the coating comprises at least one non-stoichiometric oxide, carbide or nitride.

Preferably, the coating comprises a non-stoichiometric mixture.

For example, the diaphragm is a diaphragm for a transducer for determining a pressure of the fluid medium.

Preferably, a metallic material is an alloy of chemical elements comprising at least one metal and at least one further chemical element.

The diaphragm is intended for separating a space accommodating a hydrogen-containing fluid medium from another space. A hydrogen-containing fluid medium comprises at least 1% by volume of hydrogen and is also called corrosive or corrosive fluid medium in the following text.

The metallic material of the diaphragm is comprised of a metal or metal alloy. A metal or metal alloy includes, for example, nickel based alloys such as electroformed nickel, nickel 270, nickel 301, K-Monel, or titanium based alloys such as pure titanium, Ti-6Al-4V, Ti-5Al-2.5Sn, Ti-11.5Mo-6Zr-4.5Sn, Alpha-2 TiAl alloy, Gamma-TiAl alloy, or copper based alloys such as OFHC copper, aluminum bronze, Be—Cu alloys, GRCop-84 (Cu-8Cr-4Nb), NARloy-Z (Cu-3Ag-0.5Zr), 70-30 Brass, or aluminum based alloys such as 1100-TO, 2011, 2024, 5086, 6061-T6, 6063, 7039, 7075-T73, or austenitic steels such as CG-27, Tenelon, A302B, A286, 216, 304L, 304N, 304LN, 305, 308L, 309S, 310, 316, 321, 347, 18-2-12 (Nitronic 32), 21-6-9 (Nitronic 40), 22-13-5 (Nitronic 50), 18-18 Plus, 18-2-Mn, 18-3-Mn, orferritic steels such as A106-Gr. B, A212-61T, A372, A515-Gr. 70, A516, A517-F (T-1), A533B, HY-80, HY-100, Iron (armco), X42, X52, X60, X65, X70, X100, 430F, 1020, 1080, C1025, 1042, 4140, 4340, or martensitic steels such as AerMet 100, D6AC, H-11, Fe-9Ni-4Co-0.20C, 410, 440A, 440C, 17-4 PH, 18Ni-250, or nickel based superalloys (superalloys) such as AF-115, AF-56, Astroloy, CM SX-2, CM SX-3, CM SX-4C, CM SX-4D, CM-SX5, Hastelloy, Haynes 230, Haynes 242, IN 100, Inconel 625, Inconel 700, Inconel 706, Inconel 713LC, Inconel 718, Inconel X-750, Inco 4005, MAR-M200, MAR-M246, MA 6000, MA 754, MERL 76, NASA-HR1, PWA 1480, PWA 1480E, Rene 41, Rene N-4, Rene 95, RR 2000, Udimet 720, Udimet 700, Waspaloy, or iron based superalloys such as A286, Incoloy 802, Incoloy 901, Incoloy 903, Incoloy 907, Incoloy 909, JBK-75, MA 956, Ni-SPAN-C, or cobalt based superalloys such as Haynes 188, MP35N, MP159, MP98T, X-45. These alloys are described in more detail in J. A. Lee, Hydrogen Embrittlement, NASA/TM-2016-218602, Alabama, US (2016), tables 2, 3 and 4. In principle, the alloys are suitable for use as metallic material for producing a diaphragm with different dimensions of the diaphragm being selected depending on the material properties. However, some alloys are only partially suitable for direct exposure to a hydrogen-containing fluid medium. By coating the metallic material it is possible for the expert to choose the metallic material of the diaphragm according to suitable physical properties such as stiffness, thermal conductivity, coefficient of thermal expansion or yield strength. The coating protects the metallic material from hydrogen-related corrosion. Hydrogen resistance of the metallic material is advantageous but not necessary.

As described in the beginning, some of the aforementioned metallic materials have coarse-grained, polycrystalline structures which are less suitable as materials for thin diaphragms with thicknesses of less than 500 μm in direct contact with a hydrogen-containing fluid medium. However, coating the diaphragm eliminates this disadvantage and thus provides a relatively large selection of materials for use as the metallic material of the diaphragm.

Preferably, the diaphragm has a thickness of less than 500 μm at least in certain areas. This is advantageous with respect to transmission of a pressure of a fluid medium from the first space to a measuring arrangement located in the second space with as little loss as possible. Furthermore, a diaphragm having a thickness of less than 500 μm exhibits lower inertia than diaphragms with higher thicknesses. This is an advantage because when the transducer is accelerated only small forces will act onto the measuring arrangement by the inert mass of the diaphragm so that a pressure measurement is not or only slightly affected by an acceleration.

Particularly preferably, the metallic material is a fine-grained steel having a structure of martensite, bainite, needle ferrite, Widmannststten ferrite or a mixture of these structures. Generally, these are not considered as hydrogen-resistant, however, surprisingly, due to their relatively fine-grained structure they have a low tendency to hydrogen embrittlement. Fine-grained structures result in longer diffusion paths which is the reason why hydrogen cannot diffuse through these materials over a short distance. Therefore, the metallic material has a certain resistance to hydrogen. Bainite, needle ferrite and Widmannststten ferrite are also known as intermediate structures. Intermediate structures include structures between martensite and pearlite. Needle ferrite is intended to mean the materials referred to as acicular ferrite in the English language.

The structures of martensite, bainite, Widmannststten ferrite, needle ferrite or a mixture of these structures are characterized by an average grain diameter of less than 20 μm and they are therefore particularly suitable for the production of thin-walled diaphragms with thicknesses of less than 500 μm. Due to the small average grain diameter, the component exhibits isotropic physical properties which is advantageous when the diaphragm is in use.

Particularly preferably, the structure comprises a martensite with partially coherent or incoherent precipitates, preferably at grain boundaries within the material as described in Metallkunde, E. Hornbogen and H. Warlimont, 4th edition, Springer Verlag 2001. Partially coherent or incoherent precipitations within the meaning of this description are described in Werkstoffkunde—Stahl—vol. 1, Verein Deutscher Eisenhuttenleute (eds.), Springer Verlag 1984 or in Pirlog, Madalina, and P. K. Pranzas. “CHARACTERIZATION OF COPPER PRECIPITATES IN FE-CU ALLOYS WITH SMALL-ANGLE NEUTRON SCATTERING”.

Incoherent and partially coherent precipitates act as hydrogen sinks.

Hydrogen accumulates at hydrogen sinks. This prevents the accumulated hydrogen from penetrating further into the material. The mobility of the hydrogen is reduced compared to a material that comprises coherent precipitates since coherent precipitates are located within a grain, however, hydrogen preferably moves along grain boundaries in the material.

The coating is part of the diaphragm. According to the invention, the metallic material of the diaphragm comprises the coating. The coating is arranged on the side of the metallic material of the diaphragm that faces towards the fluid medium that contains hydrogen.

According to the invention, the diaphragm comprises a coating. The coating serves to reduce the permeability of the diaphragm for atomic or molecular components of the fluid medium, in particular molecular and/or atomic hydrogen. The coating is arranged between the metallic material of the diaphragm and the fluid medium at least in the area which is in contact with the fluid medium during use. The coating comprises oxides, carbides or nitrides.

Oxides, carbides or nitrides are, for example, aluminum oxides, aluminum carbides, aluminum nitrides, chromium oxides, chromium nitrides, silicon oxides, silicon carbides, silicon nitrides, titanium oxides, titanium carbides, titanium nitrides, zirconium oxides or rare earth oxides. Direct contact between the metallic material of the diaphragm and the fluid medium is prevented by the coating. Direct adsorption of molecular and/or atomic components from the fluid medium at the metallic material of the diaphragm is prevented by the coating.

Since the aforementioned oxides, nitrides and carbides are substantially chemically inert compared to the steels, alloys and metallic materials mentioned in the beginning, the coating of the metallic material reduces chemical reaction or dissociation of components at the surface of the diaphragm coated in this way. The corrosion resistance of the diaphragm is further increased compared to a diaphragm without a coating.

The coating is thinner than the thickness of the metallic material.

Preferably, the thickness of the coating is at most 10% of the total thickness of the membrane. Common coating thicknesses are between 1 μm and 5 μm. Thus, the stiffness and yield strength of the membrane will be mainly determined by the metallic material.

Typically, the metallic material has a coefficient of thermal expansion of between 5·10⁻⁶ K⁻¹ and 15·10⁻⁶ K⁻¹ in the temperature range between 20° C. and 100° C. A mismatch between the metallic material and the coating is compensated to a certain extent by epitaxial effects. Adhesion of the coating to the metallic material is favored by epitaxial effects when the coating is applied using epitaxial processes.

The coating also has a coefficient of thermal expansion. Preferably, the coefficient of thermal expansion of the coating does not differ by more than 50% from the coefficient of thermal expansion of the metallic material. This prevents delamination and formation of cracks in the coating under thermal stress.

Thermal stress or a change in temperature occurs when the temperature in at least an area of the diaphragm increases or decreases by more than 10° C. relative to a temperature at any previous point in time. The time period is arbitrary and may be up to several days.

Advantageously, the diaphragm comprises an adhesion promoter layer. The adhesion promoter layer serves to prevent delamination of the coating from the metallic material. Mechanical stresses that occur when the temperature changes are thus advantageously distributed between an interface of the metallic material to the adhesion promoter layer and another interface of the adhesion promoter layer to the coating. This reduces local mechanical stresses and prevents cracks from forming under mechanical or thermal stress.

Advantageously, the adhesion promoter layer is a metal with strong oxygen affinity, for example a refractory metal, aluminum or rare earth metals. Refractory metals are titanium, vanadium, chromium, zirconium, niobium, hafnium, tantalum, molybdenum, or tungsten. The adhesion promoter layer has a purity of at least 75% by weight. A purity of at least 75% by weight means that 75% by weight of the adhesion promoter layer consists of a metal.

Preferably, the adhesion promoter layer consists of at least 90% by weight of zirconium or tungsten. Zirconium or tungsten may be readily applied in the form of a layer.

In the embodiment according to the invention, the diaphragm comprises a coating made of a non-stoichiometric oxide or a non-stoichiometric nitride or a non-stoichiometric carbide.

An oxide or a nitride or a carbide is non-stoichiometric when the chemical elements are not present in the optimal ratio for the respective mixture. Usually, for stoichiometric oxides, nitrides or carbides the optimal ratio is the most stable chemical compound.

Stoichiometric carbides are, for example, SiC (silicon carbide), Al₄C₃ (aluminum carbide), or TiC (titanium carbide).

A non-stoichiometric carbide is a mixture (1-y)M-yMCₓ (with 0<x<x_{M,C} and 0<y<=1, where M=Si with x_{Si,C}=1, or M=Al with x_{Al,C}=3/4, or Ti with x_{Ti,C}=1).

The constant x_{M,C} is dependent on the element M for carbides C. At x_{M,C} the stoichiometric ratio for the respective element M in combination with carbon C is reached. Other elements for M may also be used. The stoichiometric ratio of the carbide may be obtained from the technical literature.

Stoichiometric nitrides are, for example, AlN (aluminum nitride), CrN (chromium nitride), Si₃N₄ (silicon nitride), TiN (titanium nitride).

A non-stoichiometric nitride is a mixture (1-y)M-yMNₓ (with 0<x<x_{M,N} and 0<y<=1, where M=Al with x_{Al,N}=1, or M=Cr with x_{Cr,N}=1, or M=Si with x_{Si,N}=4/3, or M=Ti with x_{Ti,N}=1). The constant x_{M,N} is dependent on the element M for nitrides N. At x_{M,N} the stoichiometric ratio for the respective element M in combination with nitrogen N is reached. Other elements for M may also be used.

The stoichiometric ratio of the nitride may be obtained from the technical literature.

A stoichiometric oxide is, for example, Al₂O₃ (aluminum oxide), SiO₂ (silicon oxide), TiO₂ (titanium oxide), ZrO₂ (zirconium oxide), Cr₂O₃ (chromium oxide), or, in the case of a rare earth oxide Sc₂O₃, Y₂O₃, La₂O₃, CeO₂, Pr₂O₃, Nd₂O₃, Pm₂O₃, Sm₂O₃, EuO, Gd₂O₃, Tb₂O₃, Dy₂O₃, Ho₂O₃, Er₂O₃, Tm₂O₃, Yb₂O₃, Lu₂O₃.

Rare earths are Sc (scandium), Y (yttrium), La (lanthanum), Ce (cerium), Pr (praseodymium), Nd (neodymium), Pm (promethium), Sm (samarium), Eu (europium), Gd (gadolinium), Tb (terbium), Dy (dysprosium), Ho (holmium), Er (erbium), Tm (thulium), Yb (ytterbium), Lu (lutetium).

A non-stoichiometric oxide is a mixture (1-y)M-yMOₓ (with 0<x<x_{M,O} and 0<y<=1; where M=Al with x_{Al,O}=1.5, or M=Cr with x_{Cr,O}=1.5, or M=Si with x_{Si,O}=2, or M=Ti with x_{Ti,O}=2, or M=Zr with x_{Zr,O}=², or M=rare earths with x_{rare earths,O}=1 to 2). The constant x_{M,O} is dependent on the element M for oxides O. At x_{M,O} the stoichiometric ratio for the respective element M in combination with oxygen O is reached. Other elements for M may also be used. The stoichiometric ratio of the oxide may be obtained for other elements M in the technical literature.

The coating made of a non-stoichiometric oxide or a non-stoichiometric nitride or a non-stoichiometric carbide is advantageous since the coefficient of thermal expansion of non-stoichiometric oxides, nitrides or carbides may be adjusted. Preferably, the coefficient of thermal expansion of the coating does not differ by more than 50% from the coefficient of thermal expansion of the metallic material. This prevents delamination and crack formation in the coating under thermal stress. In this embodiment, the adhesion promoter layer can be omitted.

The word “or” with respect to carbides, nitrides and oxides is not to be understood as an exclusive “or”. Thus, a coating comprising a carbide may also comprise a nitride. So-called carbonitrides are explicitly disclosed as being encompassed both by a carbide-containing coating and by a nitride-containing coating. Examples are mixtures of titanium carbide and titanium nitride (titanium carbonitrides), zirconium carbide and zirconium nitride (zirconium carbonitrides), or chromium carbide and chromium nitride (chromium carbonitrides). While gold, another substantially chemically inert material, has a Vickers hardness below 100 HV 10 the exemplary oxides, nitrides and carbides have Vickers hardnesses above 100 HV. Therefore, the mechanical resistance of the coating for the metallic material is increased compared to a gold coating known from the prior art.

Vickers hardness refers to the Vickers hardness under a testing force of 10 kiloponds or 10 kgf (kilogram force), the so-called HV 10. The Vickers hardness test is described in standard DIN EN ISO 6507-1:2018 to -4:2018.

Preferably, the coating comprises non-stoichiometric aluminum oxides or non-stoichiometric titanium carbides. Aluminum oxide is known in the industry as a chemically inert material. In addition, aluminum oxide is relatively inexpensive compared to rare earths or zirconium. Titanium carbides are also widely used in the industry and are known as a cost-effective, substantially chemically inert material. While gold, another substantially chemically inert material, has a Vickers hardness below 100 HV 10 aluminum oxide has a Vickers hardness above 1500 HV 10 and, thus, when used as a coating for a metallic material exhibits an increased mechanical resistance compared to a coating made of gold. Titanium carbide has a Vickers hardness of more than 2500 HV 10 and, thus, when used as a coating for a metallic material exhibits an increased mechanical resistance compared to a coating made of gold.

In a preferred embodiment, the diaphragm comprises a coating of non-stoichiometric aluminum oxide (1-y)Al-yAlOₓ (with 0<x<1.5 and 0<y<=1). It is an advantage that the coefficient of thermal expansion of non-stoichiometric aluminum oxide may be adjusted. Preferably, the coefficient of thermal expansion of the coating does not differ by more than 50% from the coefficient of thermal expansion of the metallic material. This prevents delamination and formation of cracks in the coating under thermal stress. In this embodiment, the adhesion promoter layer can be omitted.

In one embodiment, the diaphragm comprises a coating of non-stoichiometric carbide (1-y)M-yMCₓ (with 0<x<xM,c and 0<y<=1) with a gradient within the coating, or a coating of non-stoichiometric nitride (1-y)M-yMNₓ (with 0<x<x_{M,N} and 0<y<=1) with a gradient within the coating, or a coating of non-stoichiometric oxide (1 y)M-yMOₓ (with 0<x<x_{M,O} and 0<y<=1) with a gradient within the coating. As already described, the constants x_{M,C}, X_{M,N}, x_{M,O} are dependent on the element M for carbides C, nitrides N and oxides O and are equivalent to the stoichiometric ratio for the respective element M in association with carbon C, nitrogen N or oxygen O. Within the coating, the proportion y gradually increases with increasing distance from the metallic material.

Alternatively, the proportion x gradually increases within the coating with increasing distance from the metallic material. However, also the proportion x and the proportion y may gradually increase within the coating with increasing distance from the metallic material. This has the advantage that by appropriately selecting the proportions x and y it is possible to specifically adapt the coating to the metallic material at the interface between the coating and the metallic material. The adaptation may minimize stresses at the interface and/or may be an adjusted coefficient of thermal expansion. Creating the gradient within the coating is advantageous because in this case also the physical properties gradually change within the coating. This prevents stresses or formation of cracks from occurring in the coating. At the surface that is in contact with the fluid medium the properties may be adapted to the fluid medium. Thus, the coating may also be exposed to other substances in the fluid medium besides hydrogen and, due to an appropriate selection of the proportions x and y, may be provided with a higher resistance to other substances, for example alkaline or acidic gases or liquids.

Advantageously, the coefficient of thermal expansion of the coating of non-stoichiometric oxide (1-y)M-yMOₓ, non-stoichiometric nitride (1-y)M-yMNₓ or non-stoichiometric carbide (1-y)M-yMCₓ with gradients within the coating at the interface between the metallic material and the coating differs by no more than 50% from the coefficient of thermal expansion of the metallic material.

Particularly preferably, the coating of non-stoichiometric aluminum oxide (1-y)Al-yAlOₓ (with 0<x<1.5 and 0<y<=1) comprises a gradient within the coating. The proportion y gradually increases within the coating with increasing distance from the metallic material. Alternatively, the proportion x gradually increases within the coating with increasing distance from the metallic material.

However, also the proportion x and the proportion y may gradually increase within the coating with increasing distance from the metallic material. The coefficient of thermal expansion of the coating at the interface between the metallic material and the coating does not differ by more than 50% from the coefficient of thermal expansion of the metallic material.

In one embodiment of the diaphragm having a coating made from non-stoichiometric oxide (1-y)M-yMOₓ (with 0<x<x_{M,O} and 0<y<=1) or from non-stoichiometric nitride (1-y)M-yMNₓ (with 0<x<x_{M,N} and 0<y<=1) or from non-stoichiometric carbide (1-y)M-yMCₓ (with 0<x<x_{M,C} and 0<y<=1) both with and without gradients within the coating, the diaphragm comprises at least one further coating. The further coating is arranged on the side of the coating that faces away from the metallic material. The further coating comprises stoichiometric oxide or stoichiometric carbide or stoichiometric nitride.

Advantageously, the coefficient of thermal expansion of the coating is intermediate between the coefficient of thermal expansion of the metallic material and the coefficient of thermal expansion of the further coating. In this case, the coating partially serves as the adhesion promoter layer, however, it still serves to reduce the permeability of the diaphragm for molecular and/or atomic hydrogen. By the further coating, the permeability of the diaphragm for molecular and/or atomic hydrogen is further reduced. The chemical resistance of stoichiometric oxide or stoichiometric nitride or stoichiometric carbide is higher compared to that of non-stoichiometric oxide or non-stoichiometric nitride or non-stoichiometric carbide; they are particularly chemically inert. The gradient within the coating is advantageous because it causes a gradual change in physical properties within the coating. This prevents stresses or formation of cracks in the coating. At the surface that is in contact with the further coating, the proportions x and y may be selected to minimize distortions, even under thermal stress. The further coating has a stoichiometric composition that is particularly chemically inert.

In addition, an adhesion promoter layer as described before may be provided between the coating and the metallic material.

In a special variant of the diaphragm that has a coating of a non-stoichiometric oxide, nitride or carbide with a gradient, there is a transition in the coating to a stoichiometric oxide, nitride or carbide at a distance from the interface between the coating and the metallic material.

In an alternative special variant of the diaphragm that has a coating of a non-stoichiometric oxide, nitride or carbide with a gradient, there is a transition in the coating to the respective stoichiometric oxide, nitride or carbide at a distance from the interface between the coating and the metallic material.

In a further embodiment, a stoichiometric further coating is applied on a non-stoichiometric coating. In this case, the coefficient of thermal expansion of the coating advantageously is between the coefficient of thermal expansion of the metallic material and the coefficient of thermal expansion of the further coating.

In a further embodiment, the diaphragm comprises at least one further coating with a first further coating being arranged on the side of the coating that faces towards the fluid medium and each additional further coating being arranged on the side of the previous further coating that faces towards the fluid medium. The at least one further coating comprises a non-stoichiometric carbide, nitride or oxide as does the coating described hereinbefore. However, the further coating has a different chemical composition from that of the coating. When the coating is of a titanium oxide, titanium nitride or titanium carbide, for example, the further coating may be of an aluminum nitride, aluminum oxide or aluminum carbide. Accordingly, adjacent additional coatings also have different chemical compositions. This has the advantage that the further coating in contact with the fluid medium may be adapted to the fluid medium to provide resistance to further substances contained in the fluid medium, for example. The coating may also be adapted with respect to the metallic material.

In a particular embodiment of the diaphragm having a coating of non-stoichiometric aluminum oxide (1-y)Al-yAlOₓ (with 0<x<1.5 and 0<y<=1) both with or without a gradient within the coating, the diaphragm comprises at least one further coating. The further coating is arranged on the side of the coating that faces away from the metallic material. The additional coating comprises stoichiometric aluminum oxide Al₂O₃. The coefficient of thermal expansion of the coating is between the coefficient of thermal expansion of the metallic material and the coefficient of thermal expansion of the further coating. In this case, the coating partially serves as the adhesion promoter layer, however, it still serves to reduce the permeability of the diaphragm for molecular and/or atomic hydrogen.

The permeability of the diaphragm for molecular and/or atomic hydrogen is further reduced by the further coating.

In a special variant of the diaphragm having a coating of non-stoichiometric aluminum oxide (1-y)Al-yAlOₓ (with 0<x<1.5 and 0<y<=1) with a gradient, there is a transition in the coating to stoichiometric Al₂O₃ at a distance from the interface between the coating and the metallic material.

In one embodiment, the diaphragm comprises an internal coating for reducing the permeability for molecular and/or atomic hydrogen. The internal coating is arranged on the side of the metallic material of the diaphragm that faces away from the fluid medium in the second space. In this embodiment, the internal coating comprises a non-stoichiometric oxide or nitride or carbide. The same oxides, carbides or nitrides that have already been described with regard to the coating are advantageous for this purpose. This means that the deposition may be carried out in the same way as for the coating. The internal coating is particularly advantageous where the second space that is separated by the diaphragm from the first space containing the fluid medium is a closed volume. A closed volume may be the interior of a transducer housing, for example. The additional internal coating further reduces the diffusion of molecular or atomic hydrogen through the diaphragm and, thus, leads to less hydrogen accumulation in the second space. This avoids the negative effects described above such as inflation of the diaphragm when a pressure transmission medium is arranged in the closed volume.

It is possible that in one embodiment the internal coating may not have an identical chemical composition to that of the coating. Since the coating is in contact with the fluid medium while the internal coating is not it is possible to select different coatings. For example, the internal coating or the coating may be made electrically insulating. The coating may also have a resistance to other substances which is not required for the internal coating.

As with the coating, an adhesion promoter may be optionally arranged between the internal coating and the metallic material of the diaphragm.

The invention also encompasses a transducer for determining a pressure of a fluid medium. The transducer comprises a pressure-exposed end that faces the fluid medium. The transducer comprises a housing. The transducer comprises a measuring arrangement. The measuring arrangement is arranged in the interior of the housing. The transducer comprises a diaphragm according to any of the embodiments described above. The second space corresponds to a volume in the interior of the housing.

A measuring arrangement is configured to include one or more elements for determining a pressure of a fluid medium when the measuring arrangement is disposed in a transducer. A measuring arrangement desirably includes, for example, at least one piezoelectric crystal generating piezoelectric charges as a function of a pressure acting onto the diaphragm. In one embodiment, the piezoelectric crystal is arranged in a prestressing sleeve exerting a prestress on the piezoelectric crystal. Thus, both negative and positive pressure changes can be detected. Alternatively, a measuring arrangement may also contain capacitive measuring elements that detect a mechanical deformation in the form of a change in capacitance.

Alternatively, a measuring arrangement may also comprise piezoresistive measuring elements or strain gauges, also referred to as strain gages, that detect a mechanical deformation in the form of a change in electrical resistance. The person skilled in the art is aware of the possibility of including other measuring arrangements which are used in transducers for determining a pressure of a fluid medium.

The diaphragm is arranged at the pressure-exposed end of the housing and hermetically separates the measuring arrangement from the fluid medium.

The housing and the diaphragm are connected by a bond between materials. A bond between materials is, for example, a welded connection or a soldered connection. A bond between materials by means of adhesive is also conceivable.

The diaphragm comprises a first area that is in contact with the fluid medium during use. The diaphragm comprises a second area that is not in contact with the fluid medium during use. The bond between materials is located in the second area. Bonds between materials that are made as soldered or welded connections usually exhibit a higher number of cracks or pores. Even in the case of a bond between materials by means of an adhesive, the adhesive may be damaged by the fluid medium. Therefore, the bond between materials is advantageously arranged in the second area that is not exposed to the fluid medium.

For the diaphragm comprising a coating, this will be arranged at least in the entire first area, however, it may also extend at least partially across the second area.

A second area is not in contact with the fluid medium in the sense of this specification when the concentration of corrosive components of the fluid medium in the second area is at maximum 1% of the concentration of corrosive components in the first area.

The first and second areas may be separated from one another, for example, by a sealing element. Depending on the application for which the transducer is used in terms of temperature range and pressure range, a metal gasket such as a copper gasket, a gasket made of 1.4404 or 1.4301 steels, a metal alloy sealing element or metal-coated metal alloy gaskets may be used. Plastic seals are also known for certain temperature ranges and pressure ranges, for example those made of polytetrafluoroethylene, fluoroelastomers or nitrile compounds. Other materials may also be used for a sealing element.

Preferably, the transducer is used to determine a pressure of a fluid medium where the fluid medium is corrosive and conventional transducers cannot be used.

Particularly preferably, the transducer is used to determine a pressure of a fluid medium containing at least a certain amount of molecular and/or atomic hydrogen. Hydrogen is known to cause so-called hydrogen embrittlement in a large number of metallic materials leading to hydrogen embrittlement and the reduction of yield strength when subjected to thermal and/or mechanical stress. A transducer described above significantly reduces these disadvantages.

All embodiments of a transducer described are possible as an embodiment that comprises a pressure transmission medium arranged in the second space. However, all of the embodiments described may also be carried out without a pressure transmission medium arranged in the second space.

The invention also encompasses a transducer for determining a temperature of a fluid medium. The transducer comprises a pressure-exposed end that faces the fluid medium. The transducer comprises a housing. The transducer comprises a measuring arrangement for determining a temperature of a fluid medium. The measuring arrangement is arranged in the interior of the housing. The transducer comprises a diaphragm according to any of the embodiments described above.

### BRIEF DESCRIPTION OF THE DRAWINGS

In the following, the invention will be explained in more detail by way of example with reference to the Figures in which:

FIG. 1 shows a schematic sectional view of an embodiment of a transducer comprising an embodiment of a diaphragm according to the invention where an optional coating is shown by the dash-dotted line;

FIG. 2 shows a schematic sectional view of an embodiment of a diaphragm;

FIG. 3 shows a schematic sectional view of a further embodiment of a diaphragm;

FIG. 4 shows a schematic sectional view of a further embodiment of a diaphragm;

FIG. 5 shows a schematic sectional view of a portion of a transducer comprising a diaphragm according to FIG. 3 and arranged in a wall;

FIG. 6 shows a schematic sectional view of a portion of a transducer comprising a diaphragm according to FIG. 2 and arranged in a wall;

FIG. 7 shows a schematic sectional view of a further embodiment of a diaphragm;

FIG. 8 shows a schematic sectional view of a further embodiment of a diaphragm; and

FIG. 9 shows a schematic sectional view of a further embodiment of a diaphragm.

### DETAILED DESCRIPTION OF EXEMPLARY EMBODIMENTS OF THE INVENTION

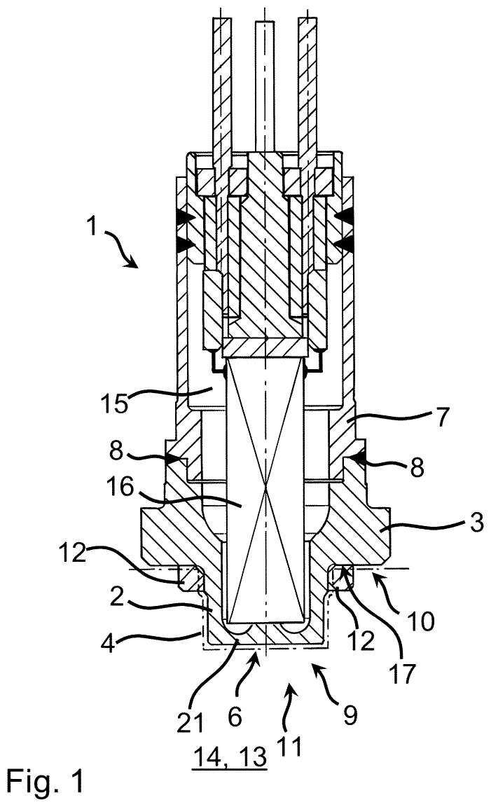

FIG. 1 shows a schematic sectional view of an embodiment of a transducer 1 with an embodiment of a diaphragm 2 according to the invention wherein an optional coating 4 is shown by the dash-dotted line.

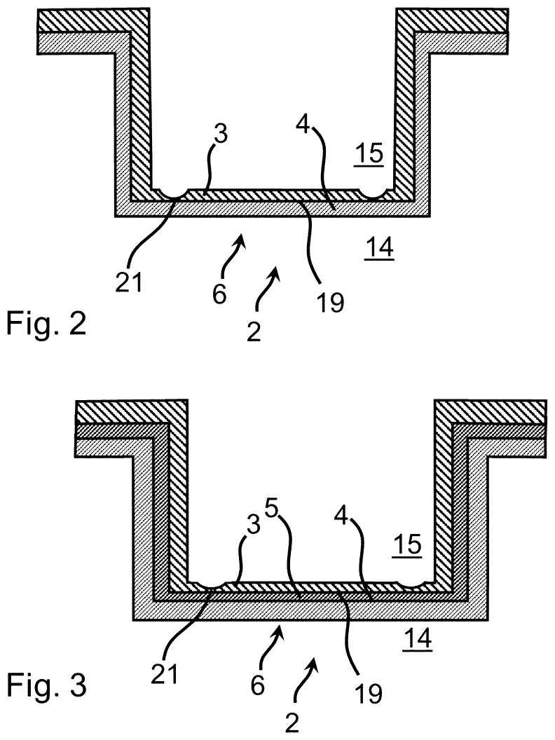

In the representation of FIG. 1, which is not drawn to scale, an optional coating 4 of the metallic material 3 is shown as a dash-dotted line. FIGS. 2 to 6 show the coating of a diaphragm 2 in the following differing from the representation shown in FIG. 1.

In the further embodiments of FIGS. 2 to 9 the reference numerals are used consistently for the same or equivalent elements.

FIGS. 2 to 4 show further embodiments of a diaphragm 2. The thickness of the diaphragm 2 and the thickness of the coating 4 are not drawn in correct scale for clarity.

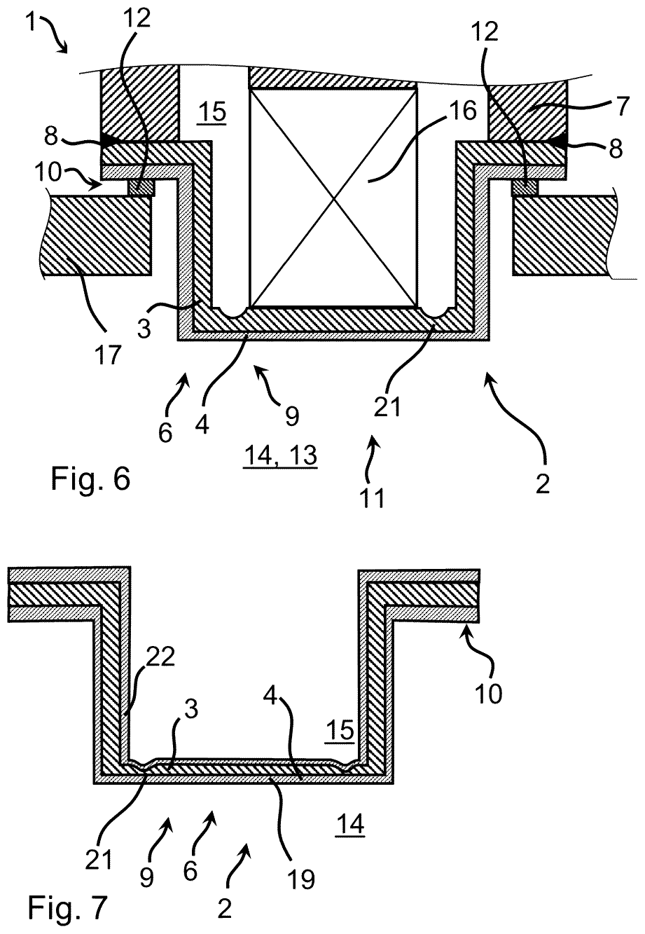

FIGS. 5 to 6 show further embodiments of a transducer 1 comprising a diaphragm 2. The thickness of the diaphragm 2 and the thickness of the coating 4 are not drawn in correct scale for clarity.

The diaphragm 2 of FIGS. 1 to 6 comprises a metallic material 3 and hermetically separates a first space 14 from a second space 15. For a fluid medium 13 present in the first space 14 at least one physical variable can be determined. A physical variable is a pressure and/or a temperature, for example.

The thickness of the diaphragm 2, the metallic material 3 and coating 4 are measured in the direction that is parallel to the plane of the figure moving from the first space 14 to the second space 15.

The surface 6 of the diaphragm 2 faces towards the fluid medium 13 when the diaphragm 2 is deployed in its intended use. The diaphragm 2 comprises a first region 9 that is in contact with the fluid medium 13 when the diaphragm 2 is in use as schematically shown in FIGS. 1, 5, 6 and 7 for example. The diaphragm 2 comprises a second region 10 that is not in contact with the fluid medium 13 when in use, as shown in FIGS. 1, 5 and 6 for example.

Advantageously, the diaphragm 2 comprises a thin-walled region 21. The thin-walled region 21 preferably has a thickness of less than 500 μm to transmit a pressure of a fluid medium 13 from the first space 14 to a second space 15 with as little loss as possible.

In the embodiments shown in FIGS. 1 to 6, the diaphragm 2 comprises the coating 4 for reducing the permeability for molecular or atomic hydrogen, said coating 4 being arranged between the metallic material 3 of the diaphragm 2 and the fluid medium 13 at least in the area which is in contact with the fluid medium 13 during use. The coating 4 comprises a non-stoichiometric carbide, nitride or oxide described above. The dash-dotted line representing the coating in FIG. 1 indicates that the coating is optional.

In the embodiments shown in FIGS. 3 and 5, the diaphragm 2 comprises an adhesion promoter layer 5 for preventing delamination of the coating 4 from the metallic material 3 of the diaphragm 2.

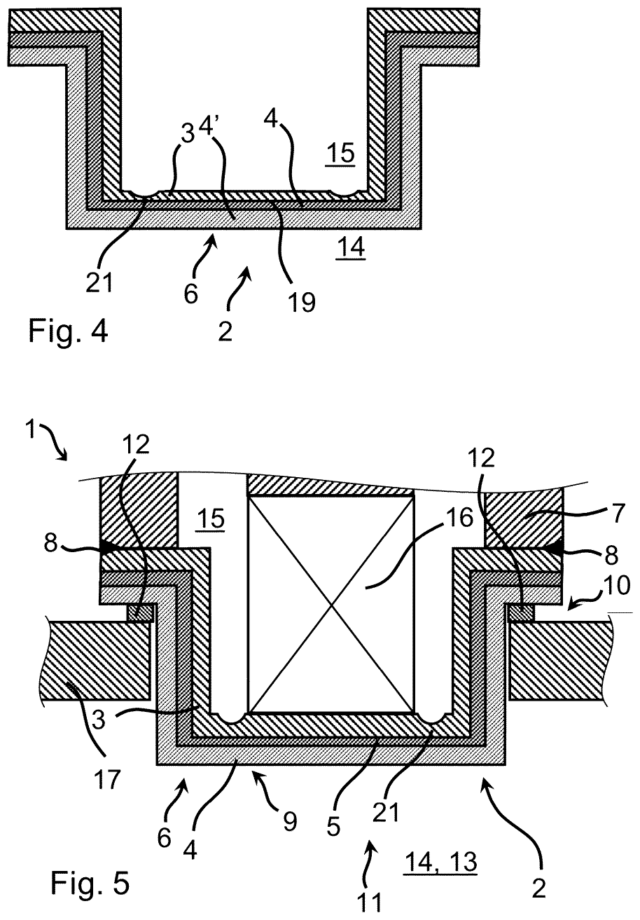

In the embodiment according to FIG. 4, the diaphragm 2 comprises a further coating 4′ arranged on the side of the coating 4 that faces away from the metallic material 3.

In the embodiment according to FIG. 9, the diaphragm 2 comprises at least one further coating 4′, 4″, 4″′, . . . arranged on the side of the coating 4 that faces away from the metallic material 3. The further coating 4′, 4″, 4″′, . . . comprises a non-stoichiometric carbide, nitride or oxide similar to the coating 4 described above.

In the embodiment according to FIG. 7, the diaphragm 2 comprises, for example, an internal coating 22 in addition to a coating 4 on the side of the metallic material 3 that faces towards the fluid medium 13. The internal coating 22 is arranged to face the second space 15 on the side of the metallic material 3 of the diaphragm 2 that faces away from the fluid medium 13 when in use. Although not represented in the Figures, an internal coating 22 may also be provided in other embodiments.

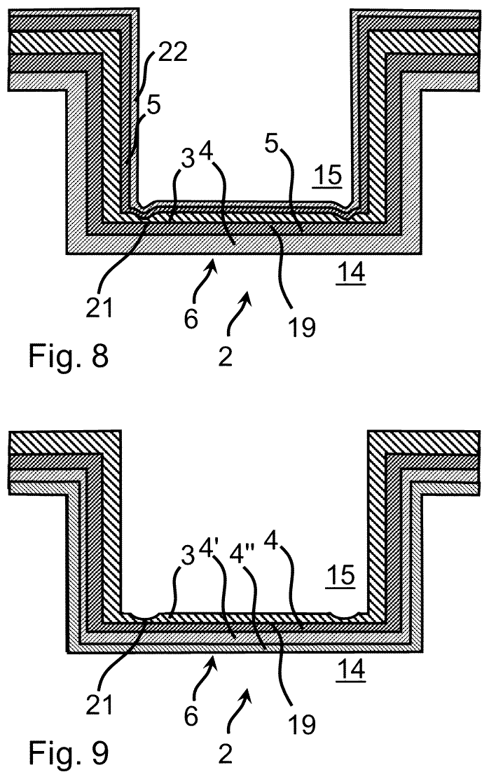

In the embodiment according to FIG. 8, the diaphragm 2 comprises a coating 4 and an adhesion promoter layer 5 on the side of the metallic material 3 of the diaphragm 2 that faces towards the fluid medium 13. This embodiment of the diaphragm 2 additionally comprises an adhesion promoter layer 5 deposited on the side of the metallic material 3 that faces away from the fluid medium 13, which adhesion promoter layer 5 joins an internal coating 22 to the metallic material 3.

FIG. 1 and FIGS. 5 to 6 each show an embodiment of a diaphragm 2 introduced in a transducer 1 for determining a pressure of a fluid medium 13. The transducer 1 comprises a pressure-exposed end 11 facing towards the fluid medium 13 when in use. The transducer 1 comprises a housing 7. A measuring arrangement 16 is arranged in the housing 7. Each embodiment of a transducer 1 according to FIG. 1, 5 or 6 represents a diaphragm 2 according to the invention.

The diaphragm 2 is arranged at the pressure-exposed end 11 of the transducer 1 and hermetically separates the measuring arrangement 16 from the fluid medium 13. The housing 7 and diaphragm 2 are joined to each other by a bond between materials 8. The diaphragm 2 comprises a first region 9 that is in contact with the fluid medium 13 when the diaphragm 2 is in use. The diaphragm 2 comprises a second region 10 that is not in contact with the fluid medium 13 when in use. The first and second regions 9, 10 are separated from each other by a sealing element 12 when the transducer 1 is in use. In each of the embodiments shown, the bond between materials 8 is arranged in the second region 10.

It is also conceivable, however, to arrange the bond between materials 8 in a region 9, 10 that is in contact with the fluid medium 13. In this case, the bond between materials 8 is advantageously completely covered by the coating 4.

FIGS. 5 and 6 show the transducer 1 for use in determining a pressure of a fluid medium 13 inserted into a wall 17. For example, the wall 17 may be a wall 17 of a tank for holding a fluid medium 13, of a compressor, a heat pump, a refrigeration machine, a line for transporting a fluid medium 13, a combustion chamber of an internal combustion engine or a gas turbine.

It is, of course, possible to combine features of the embodiments of the diaphragm 2 or of the transducer 1 disclosed in this document with each other. Furthermore, embodiments comprising a combination of features of the embodiments described herein are explicitly encompassed by this document.

### LIST OF REFERENCE NUMERALS

1 transducer
2 diaphragm
3 metallic material
4 coating
4′ coating
5 adhesion promoter layer
6 surface
7 housing
8 bond of materials
9 first region
10 second region
11 pressure-exposed end
12 sealing element
13 fluid medium
14 first space
15 second space
16 measuring arrangement
17 wall
19 interface
21 thin-walled region
22 internal coating

1. A diaphragm for hermetically separating a first space from a second space that is configured to contain a fluid medium, which includes hydrogen, the diaphragm comprising:
a metallic material disposed to face towards the second space;
a coating disposed between the metallic material and the second space, wherein the coating is configured for reducing the permeability for molecular and/or atomic hydrogen;
wherein the coating includes at least one non-stoichiometric oxide, carbide or nitride comprising aluminum oxide, aluminum carbide, aluminum nitride, chromium oxide, chromium nitride, silicon oxide, silicon carbide, silicon nitride, titanium oxide, titanium carbide, titanium nitride, zirconium oxide or rare earth oxides.

2. The diaphragm according to claim 1, wherein the coating comprises a non-stoichiometric carbide mixture (1-y)M-yMCₓ (with 0<x<x_{M,C} and 0<y<=1, where M=Si with x_{Si,C}=1, or M=Al with x_{Al,C}=3/4, or M=Ti with x_{Ti,C}=1);
or wherein the coating comprises a non-stoichiometric nitride mixture (1-y)M-yMNₓ (with 0<x<x_{M,N} and 0<y<=1, where M=Al with x_{Al,N}=1, or M=Cr with x_{Cr,N}=1, or M=Si with x_{Si,N}=4/3, or M=Ti with x_{Ti,N}=1);
or wherein the coating (4) comprises a non-stoichiometric oxide mixture (1-y)M-yMOₓ (with 0<x<x_{M,O} and 0<y<=1; where M=Al with x_{Al,O}=1.5, or M=Cr with x_{Cr,O}=1.5, or M=Si with x_{Si,O}=2, or M=Ti with x_{Ti,O}=2, or M=Zr with x_{Zr,O}=2, or M=rare earths with x_{rare earths,O}=1 to 2).

3. The diaphragm according to claim 2, wherein the coating comprises a non-stoichiometric mixture (1-y)M-yMOₓ or (1-y)M-yMNₓ or (1-y)M-yMCₓ with a gradient within the coating such that within the coating the proportion y gradually increases with increasing distance from the metallic material;
or wherein the coating comprises a non-stoichiometric mixture (1-y)M-yMOₓ or (1-y)M-yMNₓ or (1-y)M-yMCₓ with a gradient within the coating such that within the coating the proportion x gradually increases with increasing distance from the metallic material;
or wherein the coating comprises a non-stoichiometric mixture (1-y)M-yMOₓ or (1-y)M-yMNₓ or (1-y)M-yMCₓ with a gradient within the coating such that within the coating the proportion x and the proportion y gradually increase with increasing distance from the metallic material.

4. The diaphragm according to claim 3, wherein the coating comprises a non-stoichiometric mixture (1-y)M-yMOₓ or (1-y)M-yMNₓ or (1-y)M-yMCₓ with a gradient within the coating such that there is a gradual transition of the coating into a stoichiometric mixture of a carbide, nitride or oxide at a distance from the interface between the coating and the metallic material.

5. The diaphragm according to claim 1, wherein the coating is thinner than the thickness of the metallic material or wherein the thickness of the coating does not exceed 10% of the thickness of the diaphragm.

6. The diaphragm according to claim 1, wherein the coating has a coefficient of thermal expansion; wherein the metallic material has a coefficient of thermal expansion; wherein at an interface between the metallic material and the coating the coefficient of thermal expansion of the coating does not differ by more than 50% from the coefficient of thermal expansion of the metallic material.

7. The diaphragm according to claim 1, further comprising at least one further coating; wherein the at least one further coating is arranged on a side of the coating that faces away from the metallic material; and wherein the at least one further coating comprises stoichiometric oxide, carbide or nitride.

8. The diaphragm according to claim 7; wherein the coating has a coefficient of thermal expansion; in that the at least one further coating has a coefficient of thermal expansion; wherein the metallic material has a coefficient of thermal expansion; and wherein the coefficient of thermal expansion of the coating has a value between that of the coefficient of thermal expansion of the metallic material and the coefficient of thermal expansion of the at least one further coating.

9. The diaphragm according to claim 1, further comprising an adhesion promoter layer that prevents delamination of the coating from the metallic material of the diaphragm; wherein the adhesion promoter layer is arranged between the metallic material of the diaphragm and the coating; and wherein the adhesion promoter layer comprises aluminum or rare earth metals or a refractory metal including titanium, vanadium, chromium, zirconium, niobium, hafnium, tantalum, molybdenum, or tungsten.

10. The diaphragm according to claim 18, wherein the adhesion promoter layer has a purity of at least 75% by weight; or wherein the adhesion promoter layer comprises at least 90% by weight of zirconium or tungsten.

11. The diaphragm according to claim 1, further comprising an internal coating for reducing the permeability for molecular and/or atomic hydrogen, which internal coating is arranged in the second space on a side of the metallic material of the diaphragm that is disposed to face away from the fluid medium.

12. The diaphragm according to claim 11, wherein the internal coating comprises a non-stoichiometric carbide mixture (1-y)M-yMCₓ (with 0<x<x_{M,C} and 0<y<=1, where M=Si with x_{Si,C}=1, or M=Al with x_{Al,C}=3/4, or M=Ti with x_{Ti,C}=1);
or wherein the coating comprises a non-stoichiometric nitride mixture (1-y)M-yMNₓ (with 0<x<x_{M,N} and 0<y<=1, where M=Al with x_{Al,N}=1, or M=Cr with x_{Cr,N}=1, or M=Si with x_{Si,N}=4/3, or M=Ti with x_{Ti,N}=1);
or wherein the coating comprises a non-stoichiometric oxide mixture (1-y)M-yMOₓ (with 0<x<x_{M,O} and 0<y<=1; where M=Al with x_{Al,O}=1.5, or M=Cr with x_{Cr,O}=1.5, or M=Si with x_{Si,O}=2, or M=Ti with x_{Ti,O}=2, or M=Zr with x_{Zr,O}=², or M=rare earths with x_{rare earths,O}=1 to 2).

13. The diaphragm according to claim 1, wherein at least a portion of the diaphragm is defined by a thickness of less than 500 μm.

14. The diaphragm according to claim 1, wherein the metallic material is a fine-grained steel having a structure of martensite, bainite, needle ferrite, Widmannstätten ferrite or a mixture of these structures.

15. A transducer (1) for measuring a pressure of a hydrogen-containing fluid medium disposed within a space, the transducer comprising:
a pressure-exposed end that is disposable to face the fluid medium that is to be measured when the transducer is in use;
a housing;
a measuring arrangement disposed in the housing and including a sensor configured to generate a signal proportionate to a pressure detected by the sensor; and
a diaphragm that includes:
a metallic material,
a coating disposed between the metallic material and the space in which the fluid medium is disposed, wherein the coating is configured for reducing the permeability for molecular and/or atomic hydrogen,
wherein the coating includes at least one non-stoichiometric oxide, carbide or nitride comprising aluminum oxide, aluminum carbide, aluminum nitride, chromium oxide, chromium nitride, silicon oxide, silicon carbide, silicon nitride, titanium oxide, titanium carbide, titanium nitride, zirconium oxide or rare earth oxides.

16. The diaphragm according to claim 2, wherein the coating comprises non-stoichiometric titanium carbide (1-y)Ti-yTiCₓ (with 0<x<1 and 0<y<=1).

17. The diaphragm according to claim 2, wherein the coating comprises non-stoichiometric aluminum oxide (1-y)Al-yAlOₓ (with 0<x<=1.5 and 0<=y<=1).

18. The diaphragm according to claim 1, further comprising an adhesion promoter layer that prevents delamination of the coating from the metallic material of the diaphragm; wherein the adhesion promoter layer is arranged between the metallic material of the diaphragm and the coating; and wherein the adhesion promoter layer comprises aluminum or rare earth metals or a refractory metal including zirconium or tungsten.

19. The diaphragm according to claim 11, wherein the internal coating comprises a non-stoichiometric carbide mixture of non-stoichiometric titanium carbide (1-y)Ti-yTiCₓ (with 0<x<1 and 0<y<=1).

20. The diaphragm according to claim 11, wherein the coating comprises non-stoichiometric aluminum oxide (1-y)Al-yAlOₓ (with 0<x<=1.5 and 0<=y<=1).

21. The diaphragm according to claim 14, wherein the metallic material includes a fine-grained steel having a structure of martensite with partially coherent or incoherent precipitates.
